(19) United States
(12) Patent Application Publication
(10) Pub. No.: US 2017/0282292 A1
(43) Pub. Date: Oct. 5, 2017

(54) Laser Cladding Mobile Platform

(71) Applicant: Nanjing Institute of Advanced Laser Technology, Nanjing (CN)

(72) Inventors: Xuesong GAO, Nanjing (CN); Shuang LIU, Nanjing (CN); Tao ZHANG, Nanjing (CN); Meng XIAO, Nanjing (CN); Bo LI, Nanjing (CN)

(21) Appl. No.: 15/370,856

(22) Filed: Dec. 6, 2016

(30) Foreign Application Priority Data
Apr. 5, 2016 (CN) 201620272079.8

(51) Int. Cl. B23K 26/00; B25J 5/00; B23K 37/02; B25J 11/00; B23K 26/34; B23K 26/144

(52) U.S. Cl. CPC B23K 26/0096; B23K 26/34; B23K 26/144; B23K 37/0294; B25J 11/005; B25J 5/005; B62D 55/00

(57) ABSTRACT

A laser cladding mobile platform comprises a platform arranged with a laser, a powder feeder, a processing platform, an electric generator, a power distribution cabinet and a PLC control system. The laser cladding mobile platform also comprises a self-propelled mechanical arm which comprises a multivariant mechanical arm and a crawler trolley, the multivariant mechanical arm is mounted on the crawler trolley; the multivariant mechanical arm is equipped with a laser cladding head at its end, the laser inputs laser light into the laser cladding head through optical fibers, the powder feeder is connected to the laser cladding head through a powder feeding tube, the electric generator supplies power for all the devices via the power distribution cabinet, the PLC control system controls the operation of each device.

This application claims priority to Chinese Patent Application Ser. No. CN201620272079.8 filed on Apr. 5, 2016.

### TECHNICAL FIELD

The present invention belongs to the field of the laser application technology, and in particular, relates to a laser cladding mobile platform, which is suitable for the surface cladding and repairing of high value-added, precision or large-sized components and parts.

### BACKGROUND ART

Laser cladding technology refers to a technique method thereby placing the selected coating material on the coated surface of a matrix with different filling methods, and enabling the coating material to fuse simultaneously with a thin layer of the matrix surface under the radiation of laser, and to form a surface coating with extremely low dilution and in metallurgical bonding with the matrix material after a rapid solidification, so that the performances of the matrix material surface are remarkably improved such as wear resistance, corrosion resistance, heat resistance, antioxidation and appliance properties.

Laser cladding technology has a number of excellent qualities, it has a fast cooling rate during processing, which is categorized as a fast solidification, and thus fine-grained microstructures can be obtained or a new phase which cannot be produced by an equilibrium state can be generated easily; the coating obtained is low in dilution, resulting a stable metallurgical bonding or interface diffusion bonding with the matrix, further, a fine low-dilution coating can be obtained by adjusting the parameters of laser technique, and the components and dilution thereof are both controllable; the heat input and distortion are comparatively small, especially when adopting fast cladding with high power density, and the deformation can be reduced to a range within assembling tolerance of parts; the selection on the coating powder has few restrictions, hence it is particularly suitable for cladding on the surface of metal materials of low fusion points with alloys of high fusion points; the cladding layer has a large range of thickness, and the cladding area is selectable, i.e. a laser light beam can be applied to target the inaccessible areas for conducting cladding processing; this technology has an extraordinary cost performance and can be automated readily.

For the above-mentioned advantages, the laser cladding becomes an ideal method for repairing and processing parts at present. However, the processing objectives and environment on site may cause obstacles to the application of laser cladding, for example, large-sized devices as well as components and parts, such as electric generators, steam turbine rotor axes and plane turbine blades, are difficult to transport and cost much in transportation because of their bulk volume and weight; furthermore, there also exist application situations where parts inconvenient to assemble or disassemble are repaired, precision parts inappropriate to transport are repaired or confidential parts allowed for processing only on site are repaired, the ideal repairing method asks for transporting the laser cladding equipment to the site and operating there, thus a higher requirement is put forward on the flexibility and convenience of the laser cladding equipment in order to achieve convenient mobility and adaption to various working environments on site.

In the prior art, the Chinese patent No. 200520090374.3 discloses a mobile laser processing system, wherein a laser generator and a laser processor are kept at respective mounting bases on the same stand, and the support of the stand is equipped with up-down adjusting units for maintaining the laser generator and the laser processor at the same level. Although the invention provides a cladding laser processor that is simple in structure and convenient to assemble and disassemble, it does not relate to the motion part, control part or other parts of the system. The Chinese patent No. 200810000660.4 discloses a mobile laser repairing equipment, wherein a multivariant mechanical arm is used to drive a laser, all the components of the equipment are arranged on a vehicle used as a mobile carrier, it is easy to transport but it is still inconvenient and inflexible to use each component when processing; and the carrier of the equipment is a vehicle which is less convenient during use, the system lack the controlling function of self-adaption to the size of the fusion pool. The Chinese patent No. 201310016660.4 discloses a mobile laser cladding and repairing system, with focus on the design, without a mobile trolley, system-integrated by a crawler trolley, a six-axis robot, a laser, a laser cladding head, a coaxial powder feeding head, a powder feeder, a PLC control system, a positioner, an auxiliary device, a camera, a laser 3D sensor and a graphic processing system. Although the patent discloses that the components of the equipment as a whole are arranged on a mobile platform and added with a positioner as a processing platform which way provides the repairing operation with more convenience and flexibility, the constitution of the equipment is still to be further improved.

### SUMMARY OF THE INVENTION

An objective of the present invention is to overcome the shortcomings of the prior art, and provide a laser cladding mobile platform that is more convenient and flexible in transportation and repairing operation, especially suitable for conducting surface cladding and repairing on parts on site under complicated environments.

In order to solve the above-mentioned technical problems, the technical solution of the present invention is:

a laser cladding mobile platform, comprising a platform arranged with a laser, a powder feeder, a processing platform, a power supply system and a PLC control system. The laser cladding mobile platform also comprises a self-propelled mechanical arm comprising a multivariant mechanical arm and a crawler trolley, the multivariant mechanical arm is mounted on the crawler trolley; the multivariant mechanical arm is equipped with a laser cladding head at its end, the laser inputs laser light into the laser cladding head through optical fibers, the powder feeder is connected to the laser cladding head through a powder feeding tube.

Preferably, the power supply system comprises an electric generator and a power distribution cabinet, so that the power supply system can supply power for the laser cladding mobile platform independent of an external power source.

Preferably, a water cooler is provided on the mobile platform for cooling down the laser to prevent the laser from being damaged by excess temperature.

Preferably, the processing platform is a positioner.

Preferably, the multivariant mechanical arm is a six-axis-controlled mechanical arm.

Preferably, the multivariant mechanical arm is mounted on the crawler trolley via a hydraulic beam base.

Preferably, a hydraulic column is provided at the tail end of the crawler trolley.

Preferably, the laser cladding head is fixed on the multivariant mechanical arm via a flange plate.

Preferably, the operation interface of the PLC control system is installed on the crawler trolley.

The present laser cladding mobile platform has the characteristics of being convenient in transportation and flexible in processing, the independently movable mechanical arm ensures the equipment's better adaption to the complicated environment on site, and the platform can provide different processing methods by coordinating with multiple types of processing objectives.

### BRIEF DESCRIPTION OF THE DRAWINGS

FIG. 1 is a structure layout diagram of the laser cladding mobile platform of the present invention;

FIG. 2 is a front view diagram of the self-propelled mechanical arm of the present invention; and

FIG. 3 is a top view diagram of the self-propelled mechanical arm.

1: mobile platform; 2: self-propelled mechanical arm; 21: six-axis-controlled mechanical arm; 221: laser cladding head; 22: crawler trolley; 222: hydraulic column; 3: laser; 31: optical fiber; 4: powder feeder; 41: powder feeding tube; 5: processing platform; 61: electric generator; 62: power distribution cabinet; 7: water cooler; and 71: water pipe.

### DETAILED DESCRIPTION OF THE INVENTION

The present invention will be further described through embodiments with reference to the accompanying drawings for a better understanding.

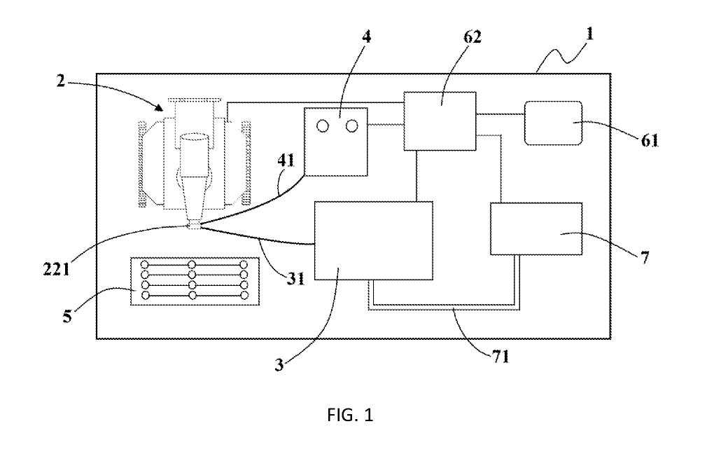

As is shown in FIG. 1, the devices arranged on the mobile platform of this embodiment comprise a laser 3, a water cooler 7, a powder feeder 4, a processing platform 5, an electric generator 61, a power distribution 62 and a self-propelled mechanical arm 2.

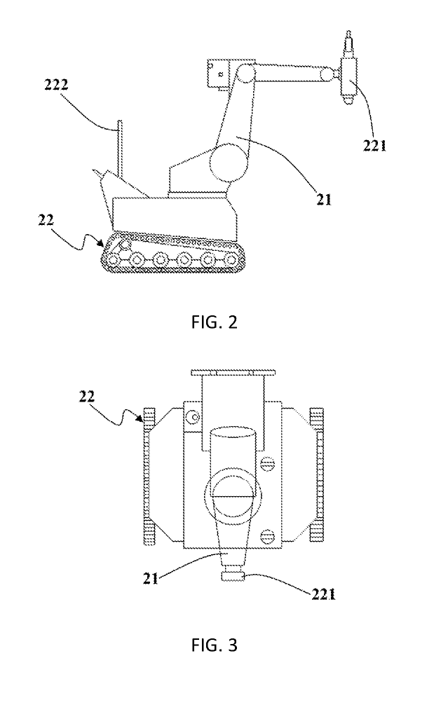

The specific structure of the self-propelled mechanical arm 2 is shown in FIG. 2 and FIG. 3, the multivariant mechanical arm is mounted on the crawler trolley 22; this embodiment adopts the six-axis-controlled mechanical arm 21 commonly used in the industry as the multivariant mechanical arm, the six-axis-controlled mechanical arm 21 is mounted on the crawler trolley 22 via a hydraulic beam base, in this way the mechanical arm is more stable during operation; the laser cladding head 221 is fixed on the six-axis-controlled mechanical arm 21 at its end; the motion of the mechanical arm is controlled through programming of the PLC control system so as to complete the scanning path of the laser cladding technique; the interface of the PLC control system is installed on the crawler trolley 22, the crawler trolley 22 can be pushed to travel by hand manipulation and can also travel under the control of the output signal sent by the PLC control system; the hydraulic column 222 is provided at the tail end of the crawler trolley 22, the hydraulic column 222 can be raised and lowered, and it is used for seizing and connecting the wires and tubes of other devices. The crawler trolley 22 adopted by the self-propelled mechanical arm 2 can cope well with adversities such as rugged areas when processing on site and too much clutters on the ground, having a better performance of adapting to rugged environments than wheeled vehicles.

The laser 3 inputs laser light into laser cladding head 221 through the optical fiber 31, the laser 3 is connected to the water cooler 7 through the water pipe 71 which guarantee of a steady temperatures of the internal elements and optical fiber heads of the laser 3, in avoidance of the damage on the laser caused by excess temperature; usually fixed at the bottom of the laser cladding head 221, the powder feeder 4 is in communication with the coaxial powder feeding head on the laser cladding head 221 via the powder feeding tube 41, the powder feeder continuously delivers powder materials for cladding through the powder feeding tube, the flows of powder from the coaxial powder feeding head converge at the position where laser lights radiated by the laser cladding head 221 focus; in this embodiment, a positioner is adopted in the processing platform 5, and small and middle-sized parts can be put to laser cladding experiments or processing on the processing platform 5; the electric generator 61 is connected to the power distribution cabinet 62, the electric generator 61 can continuously supply power for the equipment independently of an external power source; the power distribution 62 is connected to and supplies power for electrical appliances such as the laser 3, the self-propelled mechanical arm 2, the powder feeder 4 and the water cooler 7; all the devices of the laser cladding mobile platform are integrated by the PLC control system, and the PLC control system sends control instructions to each device when working.

Except the self-propelled mechanical arm 2, the above-mentioned devices are all arranged on the mobile platform 1, and form a mobile integrated structure; the self-propelled mechanical arm can move freely within the range under the restriction of connection according to processing requirements, and it can also be placed on the mobile platform 1, and moves along the platform carried on a vehicle, all the devices are transported to the site where cladding and repairing are needed with great mobility and flexibility, which reduces a quite deal of time and transportation costs.

The laser cladding mobile platform of this embodiment is especially applicable to on site repairing of various devices and parts, the mobile platform is transported to the repairing position on site by the vehicle when in use, if the objects to be repaired are independent or detachable small parts, the small parts can be clamped directly on the processing platform 5 which can adjust according to the requirement of the processed parts, and different processing platform can be adopted such as a positioner; if the objects to be repaired are large devices and parts or non-detachable parts, it is necessary to move the self-propelled mechanical arm to the position where laser repairing can be conducted; the six-axis-controlled mechanical arm 21 is adjusted to orient an appropriate direction and the laser cladding head 221 is targeted the position where repairing is needed; the electric generator 61 and the power distribution cabinet 62 are started, and devices such as the water cooler 7 and the laser 3 are switched on; the program of the laser 3 is adjusted, and on the premise that the laser 3 does not give an alarm, the parameters of the laser cladding technique including the power of laser, the scanning rate, the amount of powder fed and the flow of the protecting air are adjusted, and after the best parameters are determined, on site laser cladding processing can be started.

It should be understood that the above-mentioned embodiments are merely for illustrating the technical conception and features of the present invention, with the purpose to help those skilled in the art understand the content of this invention and implement on the basic rather than to give an exclusive list of them, and not to be construed as limiting the scope of the invention. Any modification or equivalent replacement according to the technical solution of the present invention without departing from the spirit and scope of what is disclosed shall fall within the scope defined by the claims of the present invention.

What is claimed is:

1. A laser cladding mobile platform comprising a mobile platform (1) arranged with a laser (3), a powder feeder (4), a processing platform (5), a power supply system and a PLC control system, characterized in that:
the laser cladding mobile platform also comprises a self-propelled mechanical arm (2), the self-propelled mechanical arm (2) comprises a multivariant mechanical arm and a crawler trolley (22), the multivariant mechanical arm is mounted on the crawler trolley (22); the multivariant mechanical arm is equipped with a laser cladding head (221) at its end, the laser (3) inputs laser light into the laser cladding head (221) through optical fibers (31), the powder feeder (4) is connected to the laser cladding head (221) through a powder feeding tube (41).

2. The laser cladding mobile platform according to claim 1, characterized in that: the power supply system comprises an electric generator (61) and a power distribution cabinet (62).

3. The laser cladding mobile platform according to claim 1, characterized in that: a water cooler (7) is provided on the mobile platform (1) to cool down the laser (3).

4. The laser cladding mobile platform according to claim 1, characterized in that: the processing platform (5) is a positioner.

5. The laser cladding mobile platform according to claim 1, characterized in that: the multivariant mechanical arm is a six-axis-controlled mechanical arm (21).

6. The laser cladding mobile platform according to claim 1, characterized in that: the multivariant mechanical arm is mounted on the crawler trolley (22) via a hydraulic beam base.

7. The laser cladding mobile platform according to claim 1, characterized in that: a hydraulic column (222) is provided at the tail end of the crawler trolley (22).

8. The laser cladding mobile platform according to claim 1, characterized in that: the laser cladding head (221) is fixed on the multivariant mechanical arm via a flange plate.

9. The laser cladding mobile platform according to claim 1, characterized in that: the operation interface of the PLC control system is installed on the crawler trolley (22).
